(19) United States
(12) Patent Application Publication
(10) Pub. No.: US 2025/0086582 A1
(43) Pub. Date: Mar. 13, 2025

(54) SHELF LABEL MANAGEMENT SYSTEM, SHELF LABEL MANAGEMENT METHOD, AND RECORDING MEDIUM

(71) Applicant: NEC Corporation, Minato-ku, Tokyo (JP)

(72) Inventors: Akira TADA, Tokyo (JP); Hiroki Sugegaya, Tokyo (JP); Yuki Tono, Tokyo (JP); Akihiko Onita, Tokyo (JP)

(73) Assignee: NEC Corporation, Minato-ku, Tokyo (JP)

(21) Appl. No.: 18/729,035

(22) PCT Filed: Feb. 4, 2022
(86) PCT No.: PCT/JP2022/004453

§ 371 Date: Jul. 15, 2024

(51) Int. Cl. G06Q 10/087

(52) U.S. Cl. CPC G06Q 10/087

(57) ABSTRACT

A shelf label management system comprising: at least one memory storing instructions; and at least one processor configured to execute the instructions to: acquire, for each electronic shelf label, data in which shelf label identification information for identifying the electronic shelf label and position information indicating a position in a facility are associated with each other; receive designation of a position on an image of the facility by means of an operation by a user; specify the position information in the facility related to the position designated; and select the electronic shelf label identified by the shelf label identification information associated with the position information in the facility based on the data acquired.

### TECHNICAL FIELD

The present disclosure relates to a shelf label management system and the like.

### BACKGROUND ART

Electronic shelf labels are widely used in stores. Generally, on the electronic shelf label, product information such as a price of a product and a name of the product is displayed.

PTL 1 describes a technique of classifying electronic shelf labels according to areas and collectively changing display information of the electronic shelf labels classified as the area designated by an operator. PTL 2 describes a technique in which video data obtained by capturing an image of a display shelf with a camera is recognized by a computer, and in a case where shortage or stock-out of products is detected in a monitoring area set based on a position of a shelf label detected, information regarding the shortage or stock-out is output.

### CITATION LIST

### Patent Literature

PTL 1: JP 2009-22663 A
PTL 2: WO 2019/087792 A1

### SUMMARY OF INVENTION

### Technical Problem

In a case where it is not known where the electronic shelf label is, for example, it may be difficult to select the electronic shelf label and check the display or change the display.

An example of an object of the present disclosure is to provide a shelf label management system and the like that facilitate designation of an electronic shelf label.

### Solution to Problem

A shelf label management system according to an aspect of the present disclosure includes an acquisition means for acquiring, for each electronic shelf label, data in which shelf label identification information for identifying the electronic shelf label and position information indicating a position in a facility are associated with each other, a position receiving means for receiving designation of a position on an image of the facility by means of an operation by a user, a designated position specifying means for specifying the position information in the facility related to the position designated, and a selection means for selecting the electronic shelf label identified by the shelf label identification information associated with the position information in the facility based on the data acquired.

A shelf label management method according to an aspect of the present disclosure includes acquiring, for each electronic shelf label, data in which shelf label identification information for identifying the electronic shelf label and position information indicating a position in a facility are associated with each other, receiving designation of a position on an image of the facility by means of an operation by a user, specifying the position information in the facility related to the position designated, and selecting the electronic shelf label identified by the shelf label identification information associated with the position information in the facility based on the data acquired.

A program according to an aspect of the present disclosure causes a computer to execute processing including acquiring, for each electronic shelf label, data in which shelf label identification information for identifying the electronic shelf label and position information indicating a position in a facility are associated with each other, receiving designation of a position on an image of the facility by means of an operation by a user, specifying the position information in the facility related to the position designated, and selecting the electronic shelf label identified by the shelf label identification information associated with the position information in the facility based on the data acquired.

The program may be stored in a non-transitory computer-readable recording medium.

### Advantageous Effects of Invention

According to the present disclosure, it is possible to facilitate designation of an electronic shelf label.

### BRIEF DESCRIPTION OF DRAWINGS

FIG. 1 is an explanatory diagram illustrating an example of a store and shelves installed in the store.

FIG. 2 is an explanatory diagram illustrating an example of connection of a shelf label management system according to a first example embodiment to other devices.

FIG. 3 is an explanatory diagram illustrating an example of an electronic shelf label.

FIG. 4 is a block diagram illustrating a configuration example of the shelf label management system according to the first example embodiment.

FIG. 5 is a diagram illustrating an example of a state before store position information in the store is associated with the electronic shelf label.

FIG. 6 is a diagram illustrating an example in which the store position information of the electronic shelf label in the store is specified.

FIG. 7 is a diagram illustrating an example in which product information associated with the store position information is displayed on the electronic shelf label.

FIG. 8 is a flowchart illustrating a first operation example regarding position association by the shelf label management system according to the first example embodiment.

FIG. 9 is an explanatory diagram illustrating an example of a state before different pieces of product information are associated one-to-one with a plurality of electronic shelf labels.

FIG. 10 is an explanatory diagram illustrating an example in which the different pieces of product information are associated one-to-one with the plurality of electronic shelf labels.

FIG. 11 is a flowchart illustrating a second operation example regarding position association by the shelf label management system according to the first example embodiment.

FIG. 12 is an explanatory diagram illustrating a first designation example of a position in a store image.

FIG. 13 is an explanatory diagram illustrating an example of the electronic shelf labels in a real store.

FIG. 14 is an explanatory diagram illustrating an example in which the product information displayed on the selected electronic shelf label is displayed on a terminal device.

FIG. 15 is an explanatory diagram illustrating an example of changing product information displayed on the selected electronic shelf label.

FIG. 16 is an explanatory diagram illustrating a second designation example of a position in a store image.

FIG. 17 is an explanatory diagram illustrating an example in which the product information displayed on the selected electronic shelf label is displayed on the terminal device.

FIG. 18 is a flowchart illustrating an operation example regarding selection of the electronic shelf label by the shelf label management system according to the first example embodiment.

FIG. 19 is an explanatory diagram illustrating an example in which the electronic shelf label is located in a different area from an area of a product associated with the electronic shelf label.

FIG. 20 is an explanatory diagram illustrating a first notification example.

FIG. 21 is an explanatory diagram illustrating a second notification example.

FIG. 22 is a flowchart illustrating an operation example regarding notification of a wrong position of the electronic shelf label by the shelf label management system according to the first example embodiment.

FIG. 23 is a block diagram illustrating a configuration example of a shelf label management system according to a second example embodiment.

FIG. 24 is a flowchart illustrating an operation example of the shelf label management system according to the second example embodiment.

FIG. 25 is an explanatory diagram illustrating a hardware configuration example of a computer.

### EXAMPLE EMBODIMENT

Hereinafter, example embodiments of a shelf label management system, a shelf label management method, a program, and a non-transitory recording medium in which the program is recorded according to the present disclosure will be described in detail with reference to the drawings. The present example embodiments do not limit the disclosed technique.

In each of the example embodiments, a facility is not limited to a particular one, may be an outdoor facility, an indoor facility, or the like, and is, for example, a store, a factory, or a warehouse. Furthermore, a fixture on which an electronic shelf label is installed is not limited to a particular one, and may be a shelf, a basket, or the like.

### First Example Embodiment

In a first example embodiment, a store is used as an example of a facility, a shelf is used as an example of a fixture, and an example of controlling output of an electronic shelf label arranged on the shelf installed in the store will be described. Therefore, position information is also referred to as store position information.

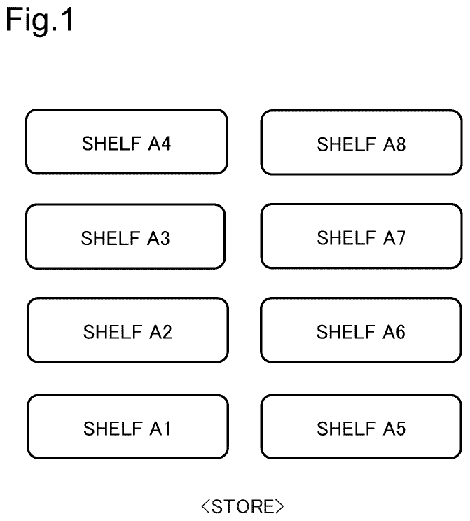

FIG. 1 is an explanatory diagram illustrating an example of a store and shelves installed in the store. In FIG. 1, a plurality of shelves A1 to A8 are installed in the store.

Here, the store may be, for example, a store such as a supermarket, a supercenter, a convenience store, a mass retailer, a home center, a drug store, a store that handles apparel products, or a private shop such as a bakery or a daily dish store, and is not limited to a particular one. Note that the number of shelves is illustrative only, is one or plural, and is not limited to a particular one.

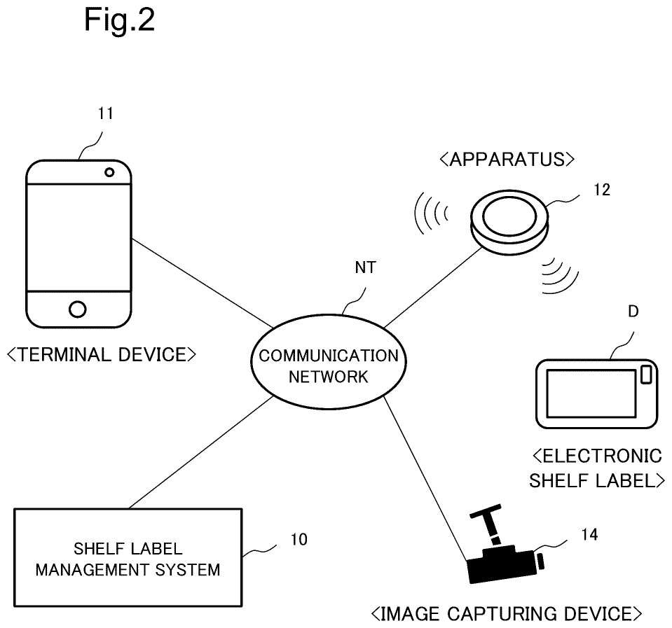

FIG. 2 is an explanatory diagram illustrating an example of connection of a shelf label management system according to the first example embodiment to other devices. A shelf label management system 10 is connected to a terminal device 11, an apparatus 12, an image capturing device 14, and the like via a communication network NT. In FIG. 2, one communication network NT is used, for example, to simplify the description, but the shelf label management system 10 may be connected to the devices and apparatuses by separate communication networks NT. The apparatus 12 is a beacon apparatus or an infrared communication apparatus.

The shelf label management system 10 controls output of an electronic shelf label D via the apparatus 12. Specifically, the shelf label management system 10 transmits information for control to the apparatus 12, and the apparatus 12 transmits the information for control to the electronic shelf label D. Here, the apparatus 12 and the electronic shelf label D can transmit and receive data by means of infrared communication and wireless communication.

The first example embodiment will be described by using one terminal device 11, for example, to simplify the description, but the shelf label management system 10 may be connected to a plurality of terminal devices 11. The image capturing device 14 is a device that is installed in the store and can capture an image of the shelf on which the electronic shelf label D is installed. The number of the image capturing devices 14 is not limited to a particular one.

The apparatus 12 has a function of performing near field communication with the electronic shelf label D. For example, the apparatus 12 is a beacon apparatus. Alternatively, the apparatus 12 has a function of performing infrared communication with the electronic shelf label D. For example, the apparatus 12 is an infrared communication apparatus.

The number of the apparatuses 12 may be any number that enables the position of the electronic shelf label D to be specified and is not limited to a particular one.

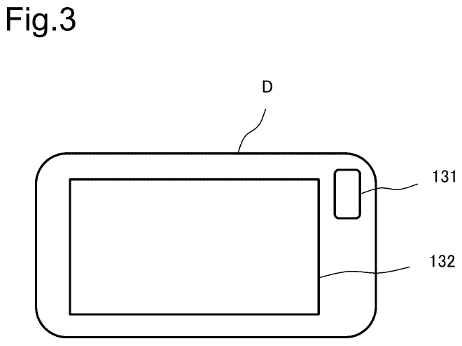

The number of the electronic shelf labels D is not limited to a particular one. The electronic shelf label D will be described with reference to FIG. 3.

FIG. 3 is an explanatory diagram illustrating an example of the electronic shelf label D. The electronic shelf label D includes, for example, a light emitting diode (LED) 131 and a display device 132. The LED 131 is an example of a lighting device, and the type of the lighting device is not limited to a particular one. The display device 132 may be electronic paper or a liquid crystal display (LCD), and is not limited to a particular one. The LED 131 and the display device 132 are provided on the front surface or the like of the electronic shelf label D. Although not illustrated, for example, a hook or the like is provided on the back surface of the electronic shelf label D, and the electronic shelf label D is installed on the shelf by the hook.

Although not illustrated, the electronic shelf label D has a function of performing infrared communication with the apparatus 12 and the terminal device 11. By using infrared communication, power consumption of the electronic shelf label D can be reduced.

Alternatively, the electronic shelf label D may have a function of performing wireless communication with the apparatus 12 and the terminal device 11.

The configuration of the electronic shelf label D is illustrative only, and is not limited to a particular one.

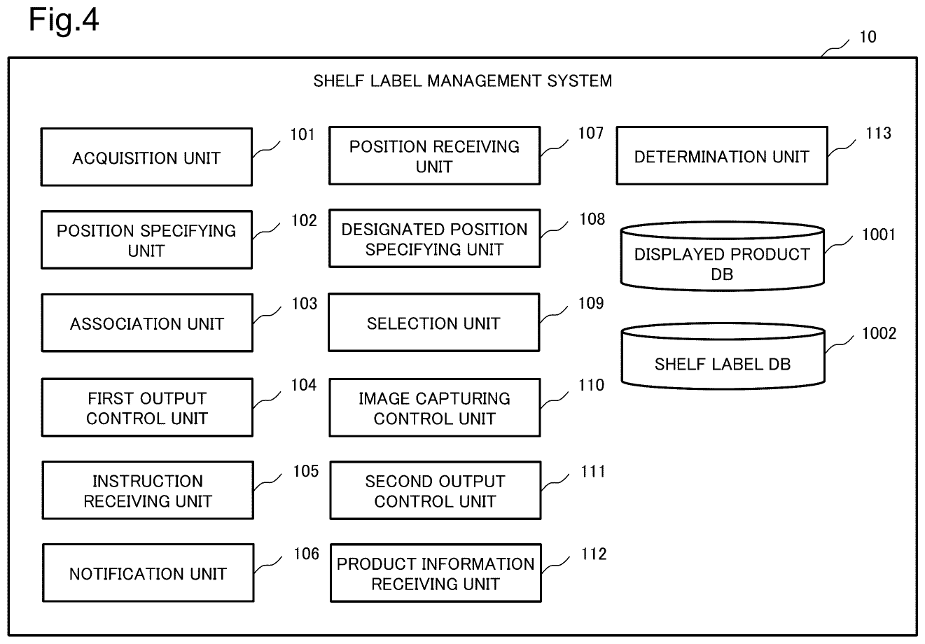

FIG. 4 is a block diagram illustrating a configuration example of the shelf label management system 10 according to the first example embodiment. The shelf label management system 10 includes an acquisition unit 101, a position specifying unit 102, an association unit 103, a first output control unit 104, an instruction receiving unit 105, a notification unit 106, a position receiving unit 107, a designated position specifying unit 108, a selection unit 109, an image capturing control unit 110, a second output control unit 111, a product information receiving unit 112, and a determination unit 113.

The shelf label management system 10 also includes a displayed product database (DB) 1001 and a shelf label DB 1002. The displayed product DB 1001 associates, for each position in the store, store position information indicating a position in the store with product information of a product displayed near the position and output to the electronic shelf label D and stores the information. The expression format of the store position information can be any format that enables the position in the store to be specified. The position in the store may be a position of an aisle, a position of a shelf, a position in the shelf such as the shelf, a level in the shelf, and an upper, lower, right, or left position, and a position indicating an area where the product is displayed. Specifically, for example, the store position information is not limited to particular information, and may be position information indicating the position of the aisle, position information indicating the position of the shelf, and position information indicating the position in the shelf such as the shelf, the level in the shelf, and the upper, lower, right, or left position, may be a coordinate value in the store, or may be identification information for identifying the apparatus 12 used for detecting the position of the electronic shelf label D. The product information may be any kind of information regarding a product to be displayed on the display device 132 of the electronic shelf label D, such as a name of the product and a price of the product.

The shelf label DB 1002 stores, for each electronic shelf label D, store position information indicating a position in the store where the electronic shelf label D is installed. For example, the shelf label DB 1002 associates shelf label identification information of the electronic shelf label D with the store position information and stores the information. Note that, for example, before receiving an association instruction of the position with each electronic shelf label D, the store position information associated with the shelf label identification information of the electronic shelf label D in the shelf label DB 1002 may be empty.

Next, each functional unit will be described.

<Example of Associating Store Position Information with Electronic Shelf Label D>

First, an example in which the store position information in a store is associated with the electronic shelf label D will be described.

The instruction receiving unit 105 receives an association instruction of the position with the electronic shelf label D. For example, the instruction receiving unit 105 may receive the association instruction of the position with the electronic shelf label D by means of an operation by a user on the terminal device 11. The instruction receiving unit 105 may receive the association instruction for each electronic shelf label D, or may collectively receive the association instruction for a plurality of electronic shelf labels D. For example, in a case where the facility is a store, the user may be a store clerk. The store clerk may input the association instruction of the position with the electronic shelf label D into the terminal device 11 after taking the electronic shelf label D to the shelf. The instruction receiving unit 105 receives the association instruction of the position with the electronic shelf label D by means of an operation by the store clerk.

Subsequently, when the instruction receiving unit 105 receives the association instruction of the position with the electronic shelf label D, the position specifying unit 102 specifies store position information indicating the position of the electronic shelf label D in the store. Specifically, for example, the position specifying unit 102 specifies the position of the electronic shelf label D in the store. For example, the position specifying unit 102 detects the position of the electronic shelf label D based on the communication intensity of wireless communication between the apparatus 12 fixedly arranged in the store and the electronic shelf label D. Alternatively, for example, the position specifying unit 102 detects the position of the electronic shelf label D based on the communication intensity of infrared communication between the apparatus 12 fixedly arranged in the store and the electronic shelf label D.

The association unit 103 associates the shelf label identification information of the electronic shelf label D with the specified store position information. Specifically, for example, the association unit 103 associates the shelf label identification information with the specified store position information and outputs the information. Associating and outputting means that, for example, the association unit 103 associates the shelf label identification information with the specified store position information and stores the information in the shelf label DB 1002 or the like.

The first output control unit 104 outputs product information associated with the store position information to the electronic shelf label D. Specifically, for example, the first output control unit 104 displays the product information on the display device 132 of the electronic shelf label D. More specifically, for example, the first output control unit 104 displays the product information on the display device 132 of the electronic shelf label D by means of wireless communication via the apparatus 12 fixedly arranged in the store. Alternatively, for example, the first output control unit 104 displays the product information on the display device 132 of the electronic shelf label D by means of infrared communication via the apparatus 12 fixedly arranged in the store.

In a case where the specified store position information is already associated with shelf label identification information of another electronic shelf label D, the association unit 103 does not need to associate the shelf label identification information of the target electronic shelf label D with the specified store position information. Since the another electronic shelf label D has already been associated, the second output control unit 111 may notify the store clerk to install the target electronic shelf label D at another place. As a notification method, the second output control unit 111 notifies the terminal device 11 possessed by the store clerk.

An example in which store position information is associated with the electronic shelf label D will be described with reference to the drawings.

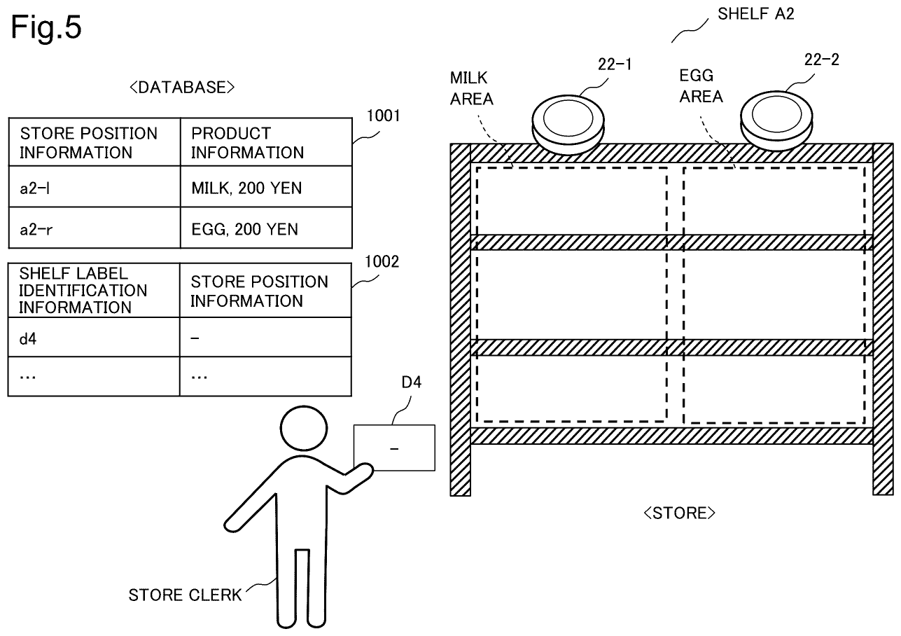

FIG. 5 is a diagram illustrating an example of a state before store position information in the store is associated with the electronic shelf label D.

In FIG. 5, the shelf A2 includes an area in which milk is displayed and an area in which an egg is displayed. In FIG. 5, for example, store position information of the area in which milk is displayed is a2-1. On the other hand, store position information of the area in which an egg is displayed is a2-r. An apparatus 12-1 capable of specifying the store position information a2-1 and an apparatus 12-2 capable of specifying the store position information a2-r are installed on the shelf.

In FIG. 5, in the shelf label DB 1002, the store position information of an electronic shelf label D4 is empty. For example, the store clerk takes the electronic shelf label D to the shelf and installs the electronic shelf label D on the shelf.

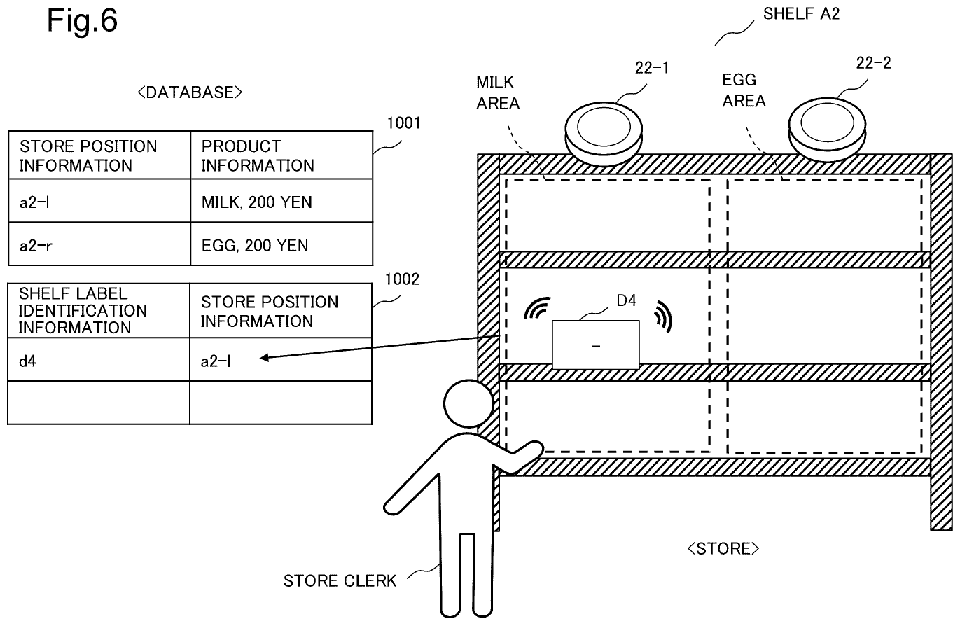

FIG. 6 is a diagram illustrating an example in which the store position information of the electronic shelf label D in the store is specified. When the instruction receiving unit 105 receives the association instruction of the position with the electronic shelf label D, the position specifying unit 102 specifies the store position information indicating the position of the electronic shelf label D in the store by means of wireless communication or infrared communication via the apparatus 12 fixedly arranged in the store. In FIG. 6, the store position information a2-1 is specified. The association unit 103 associates the store position information a2-1 with shelf label identification information d4 of the electronic shelf label D4. For example, the association unit 103 associates the store position information a2-1 with the shelf label identification information d4 of the electronic shelf label D4 and stores the information in the shelf label DB 1002. Accordingly, the shelf label identification information d4 of the electronic shelf label D4 and the product information are associated with each other via the shelf label DB 1002 and the displayed product DB 1001.

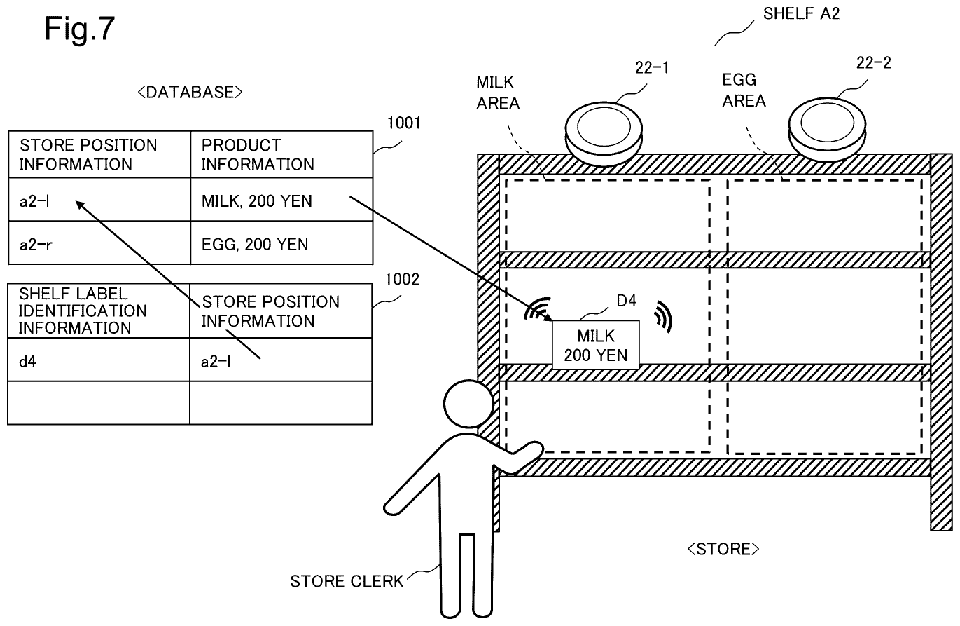

FIG. 7 is a diagram illustrating an example in which the product information associated with the store position information is displayed on the electronic shelf label D. The first output control unit 104 outputs the product information associated with the store position information a2-1 to the display device 132 of the electronic shelf label D4. As the product information, a product name “Milk” and a price “200 yen” are associated with the store position information a2-1. Therefore, the product name “Milk” and the price “200 yen” are displayed on the electronic shelf label D1.

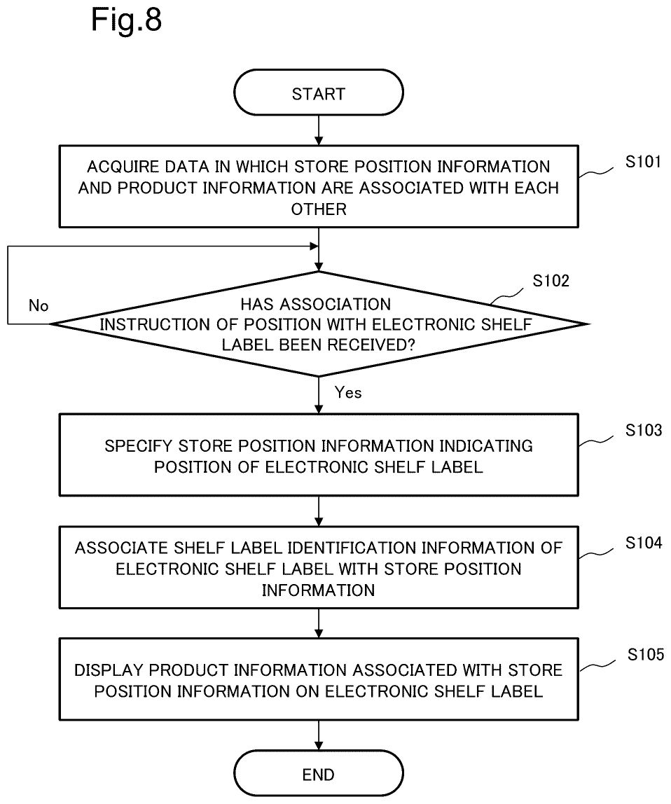

FIG. 8 is a flowchart illustrating a first operation example regarding position association by the shelf label management system 10 according to the first example embodiment. The acquisition unit 101 acquires data in which store position information and product information are associated with each other (step S101). Here, for example, in step S101, the acquisition unit 101 may acquire the displayed product DB 1001. The position receiving unit 107 determines whether an association instruction of the position with the electronic shelf label D has been received (step S102). In a case where the association instruction of the position with the electronic shelf label D has not been received (step S102: No), the store receiving unit returns to step S102.

In a case where the association instruction of the position with the electronic shelf label D has been received (step S102: Yes), the position specifying unit 102 specifies store position information indicating the position of the electronic shelf label D (step S103). In step S103, the position specifying unit 102 detects the position of the electronic shelf label D by means of wireless communication or infrared communication by the apparatus 12 fixedly arranged in the store.

Subsequently, the association unit 103 associates the shelf label identification information of the electronic shelf label D with the store position information (step S104). In step S104, the association unit 103 associates the shelf label identification information of the electronic shelf label D with the store position information and stores the information in the shelf label DB 1002.

The first output control unit 104 displays the product information associated with the store position information on the electronic shelf label D based on the acquired displayed product DB 1001 and shelf label DB 1002 (step S105). In step S105, the position specifying unit 102 displays the product information on the display device 132 of the electronic shelf label D by means of wireless communication or infrared communication by the apparatus 12 fixedly arranged in the store.

In a case where there are a large number of electronic shelf labels D, it takes time and effort for the store clerk to associate each of the electronic shelf labels D with the store position information in the store. As described above, in the first example embodiment, the shelf label management system 10 acquires, for each position in a facility, data in which position information indicating a position is associated with product information of a product displayed near the position. Then, when receiving an association instruction of a position with the electronic shelf label D, the shelf label management system 10 specifies position information indicating a position where the electronic shelf label D is arranged in the facility, associates identification information of the electronic shelf label D with the specified position information, and outputs product information associated with the specified position information to the electronic shelf label D. As a result, it is possible for a store clerk to save time and effort in a case of associating store position information with the electronic shelf label D. In addition, as compared with a case where position information of the electronic shelf label D is read from an electronic tag or the like, in the first example embodiment, the electronic shelf label D only needs to communicate with the apparatus 12 that is generally provided, and thus, the cost of the electronic tag or the like can be dispensed with, which can lead to cost reduction.

<Example of Associating Position Information with n Electronic Shelf Labels D>

Next, a case where there are n electronic shelf labels D, and where pieces of product information for m products are associated one-to-one with pieces of store position information will be described as an example. Here, the m products are different products from each other. Therefore, the pieces of product information for the m products are associated one-to-one with the pieces of store position information.

The position specifying unit 102 specifies the pieces of position information for the plurality of electronic shelf labels D on a one-to-one basis.

In a case where the pieces of position information specified for the plurality of electronic shelf labels D on a one-to-one basis are the same, the association unit 103 associates the specified pieces of position information one-to-one with the pieces of shelf label identification information for the plurality of electronic shelf labels D. Specifically, for example, in a case of associating the shelf label identification information with the product information, the association unit 103 may associate the shelf label identification information with the product information associated with the position information and store the information in the storage unit. Alternatively, in a case where the store position information in the displayed product DB 1001 is more accurate than the accuracy of the position that can be specified by the apparatus 12, the store position information and the product information may be associated with each other in the displayed product DB 1001, and the association unit 103 may associate the shelf label identification information with the store position information and store the information in the shelf label DB 1002. In the following description, a case where the store position information in the displayed product DB 1001 is more accurate than the accuracy of the store position information that can be specified by the apparatus 12 will be described as an example.

For example, in a case where pieces of store position information specified for n electronic shelf labels D are the same, and where n and m are the same, the association unit 103 associates pieces of shelf label identification information for the electronic shelf label D one-to-one with the pieces of store position information in such a way that different pieces of product information are assigned one-to-one to the n electronic shelf labels D. The state where different pieces of product information are assigned one-to-one to the n electronic shelf labels D means that different pieces of product information are displayed one-to-one on the n electronic shelf labels D.

Further, in a case where the number n of the plurality of electronic shelf labels D is larger than the number m of products specified by the product information associated with the specified store position information, the association unit 103 associates the store position information in such a way that different pieces of product information are assigned one-to-one to the pieces of shelf label identification information of m electronic shelf labels D out of the plurality of electronic shelf labels D. However, the association unit 103 does not need to associate pieces of store position information with pieces of shelf label identification information for an excessive number of electronic shelf labels D, out of the plurality of electronic shelf labels D, other than as many electronic shelf labels D as the number m of products.

Then, the first output control unit 104 displays product information associated with the store position information on the electronic shelf label D based on the displayed product DB 1001. The store clerk may perform visual check and move the electronic shelf label to an appropriate position on the shelf based on the product information displayed on the electronic shelf label D.

In addition, since no product information is displayed on each of the excessive number of electronic shelf labels D other than as many electronic shelf labels D as the number m of products, the store clerk is only required to collect the electronic shelf labels D on which no product information is displayed.

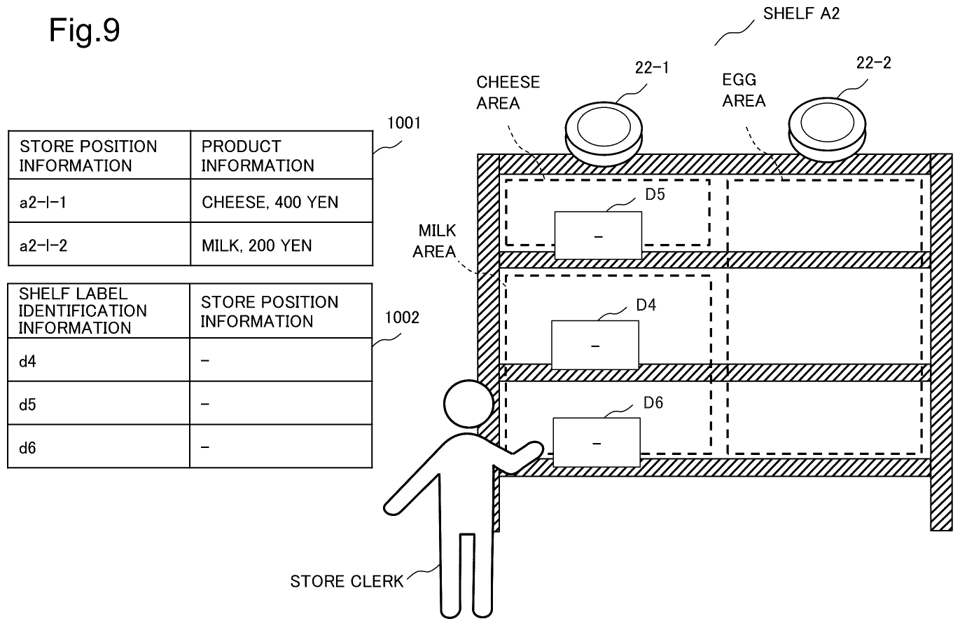

FIG. 9 is an explanatory diagram illustrating an example of a state before different pieces of product information are associated one-to-one with a plurality of electronic shelf labels D. In FIG. 9, the store position information a2-1 that can be specified by the apparatus 12 is further divided into store position information a2-1-1 and store position information a2-1-2. As the product information, a product name “Cheese” and a price “400 yen” are associated with the store position information a2-1-1. As the product information, a product name “Milk” and a price “200 yen” are associated with the store position information a2-1-2.

In FIG. 9, the store clerk arranges the electronic shelf labels D4 to D6 on the left side of the shelf. Then, when the instruction receiving unit 105 receives an association instruction of the position with the electronic shelf label D, the position specifying unit 102 specifies store position information indicating the position of each of the electronic shelf labels D in the store. Here, the store position information a2-1 is specified.

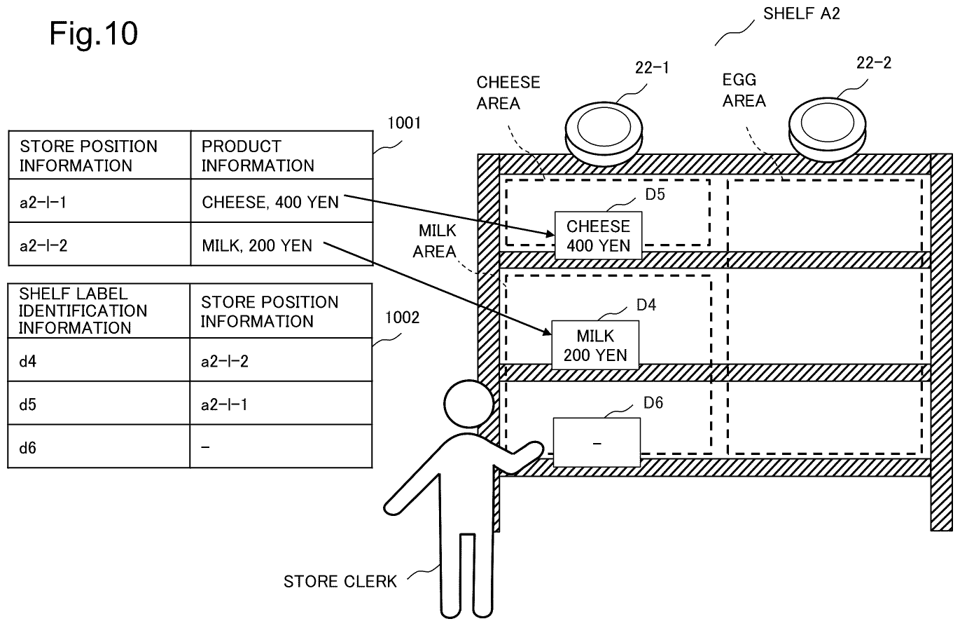

FIG. 10 is an explanatory diagram illustrating an example in which the different pieces of product information are associated one-to-one with the plurality of electronic shelf labels D. In a case where the pieces of store position information specified one-to-one for the plurality of electronic shelf labels D are the same, the association unit 103 associates position information in such a way that different pieces of product information are associated one-to-one with the pieces of shelf label identification information for the plurality of electronic shelf labels D.

Specifically, for example, the association unit 103 associates the shelf label identification information d4 of the electronic shelf label D4 with the store position information a2-1-2. Accordingly, the shelf label identification information d4 of the electronic shelf label D4 is associated with the product information of the product name “Milk” and the price “200 yen”. Specifically, for example, the association unit 103 associates shelf label identification information d5 of an electronic shelf label D5 with the store position information a2-1-1. Accordingly, the shelf label identification information d5 of the electronic shelf label D5 is associated with the product information of the product name “Cheese” and the price “400 yen”.

Then, for example, the association unit 103 associates no store position information with shelf label identification information d6 of an electronic shelf label D6.

The first output control unit 104 displays product information associated with the store position information on the electronic shelf label D4 based on the displayed product DB 1001. Then, the first output control unit 104 displays product information associated with the store position information on the electronic shelf label D5 based on the displayed product DB 1001.

In addition, for example, there is a case where the store position information a2-1-2 is associated with the electronic shelf label D4 installed in the milk area, and the store position information a2-1-1 is associated with the electronic shelf label D5 installed in the cheese area. In this case, the product information of the product name “Cheese” and the price “400 yen” is displayed on the electronic shelf label D4, and the product information of the product name “Milk” and the price “200 yen” is displayed on the electronic shelf label D5. In such a case, the store clerk is only required to check the displays of the electronic shelf label D5 and the electronic shelf label D4 and put the electronic shelf labels at appropriate positions.

In addition, since no store position information is associated with the electronic shelf label D6, no product information is displayed on the electronic shelf label D6. In this case, the store clerk may check that no product information is displayed on the electronic shelf label D6 and collect the electronic shelf label D6.

In a case where the number n of electronic shelf labels D is smaller than the number m of products, the notification unit 106 may notify the store clerk that there are not enough electronic shelf labels D. Specifically, for example, the notification unit 106 notifies the terminal device 11 of the store clerk that there are not enough electronic shelf labels D. The notification unit 106 may notify the terminal device 11 of the store clerk of the number of missing electronic shelf labels D.

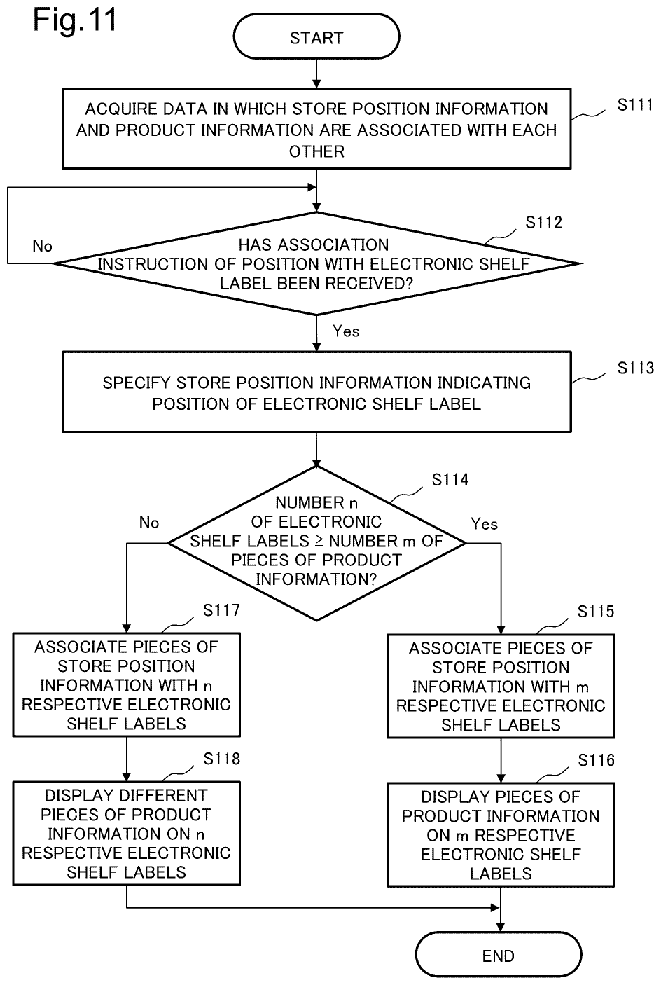

FIG. 11 is a flowchart illustrating a second operation example regarding position association by the shelf label management system 10 according to the first example embodiment. The acquisition unit 101 acquires data in which shelf label identification information and product information are associated with each other (step S111). The position receiving unit 107 determines whether an association instruction of the position with the electronic shelf label D has been received (step S112). In a case where the association instruction of the position with the electronic shelf label D has not been received (step S112: No), the position receiving unit 107 returns to step S112.

In a case where the association instruction of the position with the electronic shelf label D has been received (step S112: Yes), the position specifying unit 102 specifies store position information indicating the position of the electronic shelf label D (step S113). In step S113, the position specifying unit 102 positions the electronic shelf label D by means of wireless communication or infrared communication by the apparatus 12 fixedly arranged in the store.

Subsequently, the association unit 103 determines whether number n of electronic shelf labels D>number m of products is established (step S114). As described above, the number m of products is the number of products each specified by the product information associated with the specified store position information.

In a case where number n of electronic shelf labels D>number m of products is established (step S114: Yes), the association unit 103 associates the store position information in such a way that different pieces of product information associated with the specified pieces of store position information are assigned one-to-one to the pieces of shelf label identification information that identify m electronic shelf labels D (step S115). In step S115, the association unit 103 associates no store position information with an excessive number of electronic shelf labels D other than as many electronic shelf labels D as the number m. The first output control unit 104 displays the pieces of product information associated with the pieces of store position information on the m electronic shelf labels D (step S116) on a one-to-one basis, and ends the processing.

In a case where number n of electronic shelf labels D≥number m of products is not established (step S114: No), the association unit 103 associates the store position information in such a way that different pieces of product information associated with the specified pieces of store position information are assigned one-to-one to n electronic shelf labels D (step S117). The first output control unit 104 displays the associated pieces of product information on the n electronic shelf labels D (step S118) on a one-to-one basis, and ends the processing.

As described above, in the first example embodiment, in a case where pieces of position information specified one-to-one for a plurality of electronic shelf labels D are the same, the shelf label management system 10 associates store position information in such a way that different pieces of product information are associated one-to-one with pieces of shelf label identification information for the plurality of electronic shelf labels D. Then, the shelf label management system 10 displays the pieces of product information associated with the pieces of store position information on the display devices 132 of the plurality of electronic shelf labels D on a one-to-one basis. As a result, the store clerk is only required to arrange n electronic shelf labels D near the shelf, and then pieces of product information are displayed one-to-one on a necessary number of electronic shelf labels D. Therefore, it is possible for the store clerk to save time and effort.

### <Example of Selecting Electronic Shelf Label D>

Next, an example in which the user selects the electronic shelf label D will be described. In a case where the facility is a store, the user is, for example, a store clerk or a customer. In a case where the facility is a warehouse or a factory, the user is, for example, a worker.

The acquisition unit 101 acquires data in which shelf label identification information and store position information are associated with each other. As described above, for example, the shelf label DB 1002 associates, for each electronic shelf label D, shelf label identification information for identifying the electronic shelf label D with store position information indicating a position in a store and store the information. Therefore, for example, the acquisition unit 101 acquires the shelf label DB 1002 as this data.

The position receiving unit 107 receives designation of a position in the store by means of an operation by the user. A method for designating the position is not limited to a particular one. For example, the position receiving unit 107 receives designation of a position in the store on an image by means of an operation by the user. Here, the operation by the user is, for example, an operation by the user on the terminal device 11 of the user. The image here may be an image representing a map of the store or an image of each shelf provided in the store.

The designated position specifying unit 108 specifies store position information related to the designated position. Here, a position on the image and store position information in the store related to this position may be associated in advance and stored in a DB. In this case, the designated position specifying unit 108 specifies store position information associated with the designated position. Alternatively, the designated position specifying unit 108 may specify store position information from the position of the image capturing device 14 that has captured the image and the angle of view of the image. Alternatively, the designated position specifying unit 108 may specify a shelf near the area of the designated position from the image, and specify store position information from the position of the shelf.

The selection unit 109 selects an electronic shelf label D identified by the shelf label identification information associated with the store position information based on the acquired data. Specifically, for example, the selection unit 109 specifies the shelf label identification information associated with the store position information from the shelf label DB 1002, and selects an electronic shelf label D identified by the specified shelf label identification information.

The first output control unit 104 controls output of the selected electronic shelf label D.

For example, the first output control unit 104 may turn on the lighting device of the selected electronic shelf label D.

Furthermore, for example, the first output control means may output new product information to the selected electronic shelf label D. The new product information may be received from the user. In a case where new product information is received from the user, for example, the product information receiving unit 112 receives the new product information by means of an operation by the customer on the terminal device 11. The product information receiving unit 112 may update, in the displayed product DB 1001, the product information associated with the specified store position information to the received product information. Then, the first output control unit 104 displays the updated product information on the display device 132 of the selected electronic shelf label D.

In addition, the second output control unit 111 may output, to the terminal device 11 of the user, the product information that has been output to the selected electronic shelf label D.

For example, the user may update the product information after confirming the product information displayed on the terminal device 11. In such a case, after the second output control unit 111 outputs, to the terminal device 11 of the user, the product information that has been output to the selected electronic shelf label D, the first output control unit 104 displays the new product information on the display device 132 of the selected electronic shelf label D.

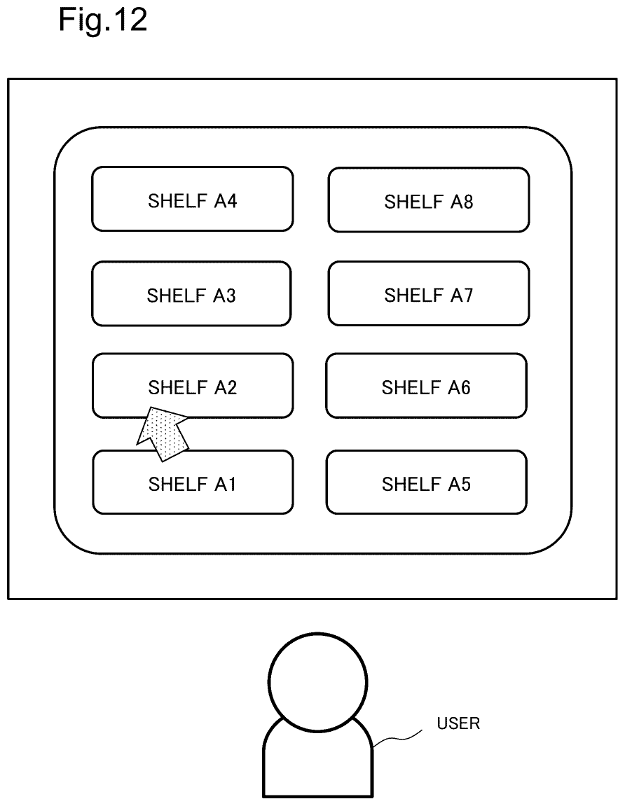

FIG. 12 is an explanatory diagram illustrating a first designation example of a position in a store image. The second output control unit 111 displays a store image on the display device of the terminal device 11. In FIG. 12, a screen including the store image is displayed on the terminal device 11. In FIG. 12, the store image is an image representing a sales floor of the store, and is, for example, an image including a plurality of shelves installed in the store. The store image may be a map of the sales floor of the store. The store image may be a picture image or a captured image. On the store image, shelf identification information enabling the shelves to be identified may be superimposed.

The position receiving unit 107 receives designation of a position on the store image by means of an operation by the user. In FIG. 12, a mark indicating a position designated by the operation by the user may be displayed on the screen. In FIG. 12, the mark is an arrow.

When receiving the designation of the position, the terminal device 11 transmits information indicating the received position to the shelf label management system 10. Then, when the position receiving unit 107 receives information indicating the position from the terminal device 11, the position receiving unit 107 can receive designation of the position in the store image. As described above, the designated position specifying unit 108 specifies store position information related to the designated position. Then, as described above, for example, the selection unit 109 selects the electronic shelf label D associated with the store position information.

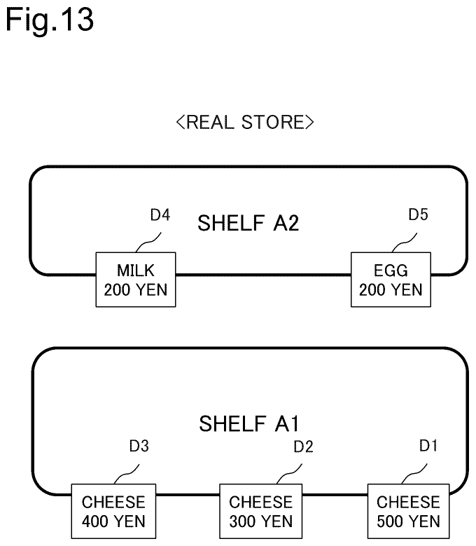

FIG. 13 is an explanatory diagram illustrating an example of the electronic shelf labels D in a real store. In FIG. 13, for example, the electronic shelf label D4 is selected. The electronic shelf label D4 and the electronic shelf label D5 are installed on the shelf A2. The electronic shelf label D4 is selected as the electronic shelf label D associated with the store position information related to the designated position.

Then, the second output control unit 111 may output, to the terminal device 11 of the user, the product information that has been output to the selected electronic shelf label D.

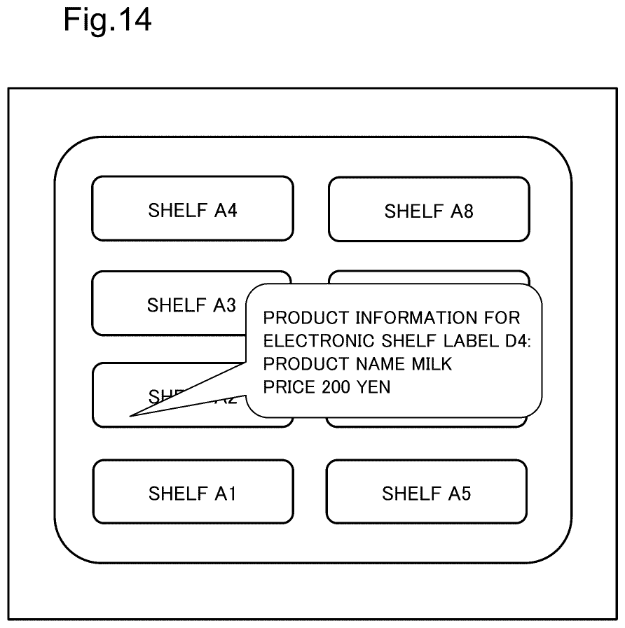

FIG. 14 is an explanatory diagram illustrating an example in which the product information displayed on the selected electronic shelf label D is displayed on the terminal device 11. In FIG. 14, the second output control unit 111 superimposes and displays the product information that has been output to the selected electronic shelf label D on the store image displayed on the terminal device 11 of the user.

Next, an example of changing product information displayed on the selected electronic shelf label D will be described.

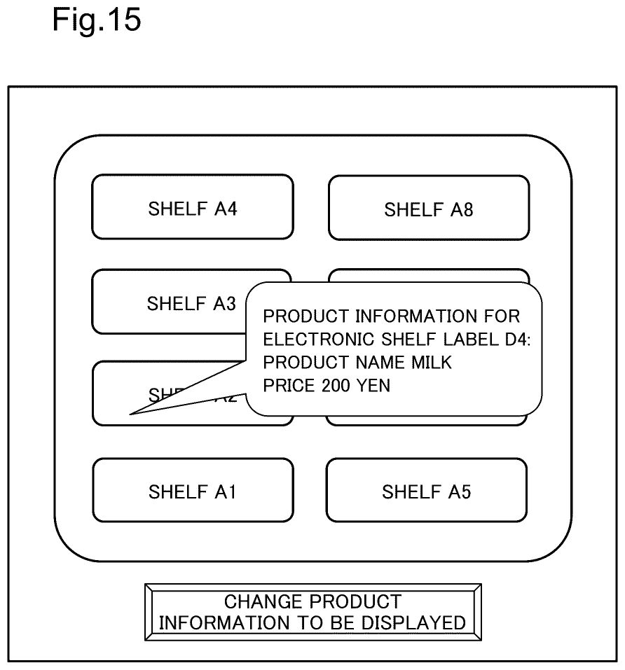

FIG. 15 is an explanatory diagram illustrating an example of changing product information displayed on the selected electronic shelf label D. A screen including a “CHANGE PRODUCT INFORMATION TO BE DISPLAYED” button as well as the store image is displayed on the terminal device 11. This button is a button for receiving an instruction for inputting new product information.

For example, when this button is tapped, the second output control unit 111 may display a screen capable of receiving new product information on the display device of the terminal device 11.

Then, for example, the product information receiving unit 112 receives new product information by an operation by the customer on the terminal device 11. The product information receiving unit 112 may update, in the displayed product DB 1001, the product information associated with the specified store position information to the received product information. Then, the first output control unit 104 displays the updated product information on the display device 132 of the selected electronic shelf label D.

With reference to the foregoing drawings, the example has been described in which the store image is, for example, an image including a plurality of shelves installed in the store. For example, the store image may be an image that enables the front surface of the shelf installed in the store to be determined. The image that enables the front surface of the shelf to be determined is a captured image of a state in which a product is displayed on the shelf and a state in which the electronic shelf label D is installed on the shelf.

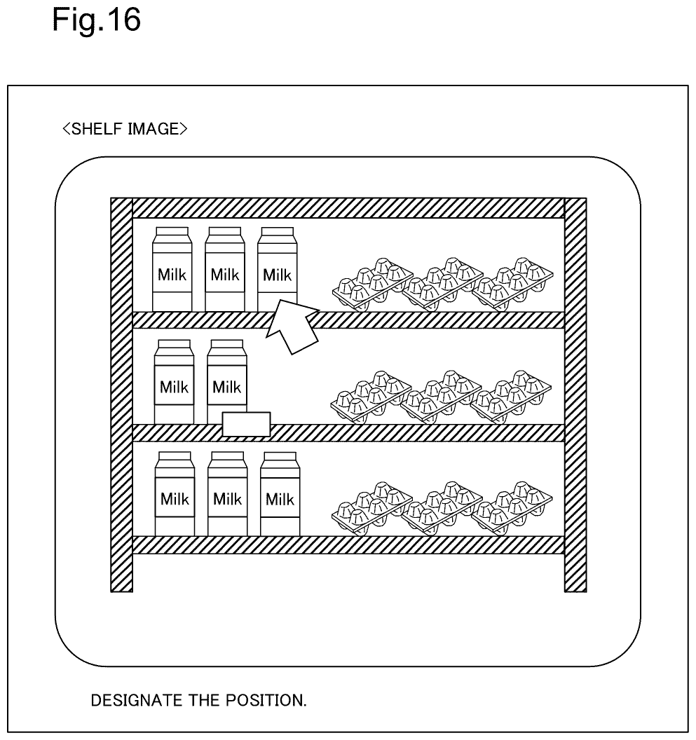

FIG. 16 is an explanatory diagram illustrating a second designation example of a position in a store image. In FIG. 16, a screen including a store image is displayed on the terminal device 11. In FIG. 16, the store image is an image focusing on one shelf of the store, and is an image obtained by capturing an image of the front surface of the shelf. The shelf in FIG. 16 is assumed to be the shelf A2. Although not illustrated, on the store image, shelf identification information enabling the shelf to be identified may be displayed. In FIG. 16, a mark indicating a position designated by an operation by the user may be displayed on the screen. In FIG. 16, the mark is an arrow.

As described above, the designated position specifying unit 108 specifies store position information related to the designated position. Then, as described above, for example, the selection unit 109 selects the electronic shelf label D associated with the store position information. Here, it is assumed that the electronic shelf label D4 has been selected.

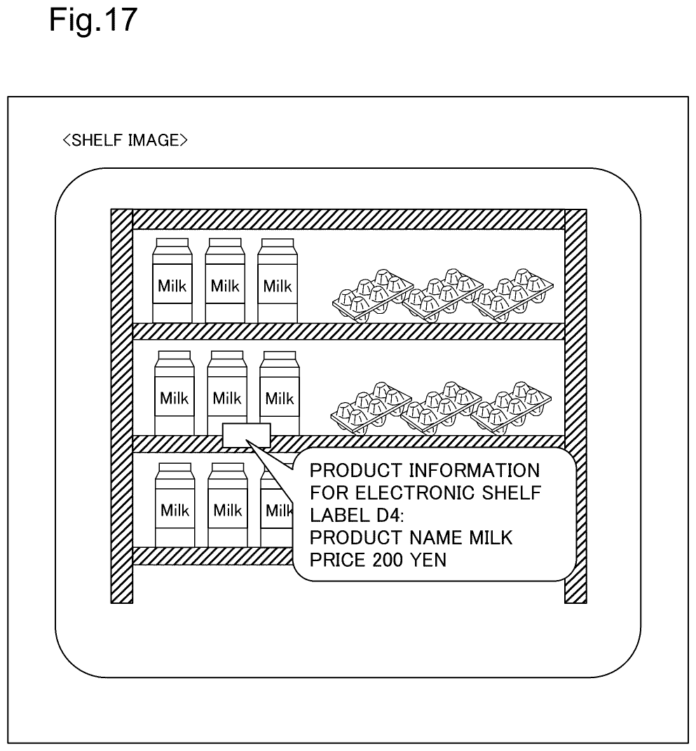

FIG. 17 is an explanatory diagram illustrating an example in which the product information displayed on the selected electronic shelf label D is displayed on the terminal device 11. In FIG. 17, the second output control unit 111 superimposes and displays the product information that has been output to the selected electronic shelf label D4 on the store image displayed on the terminal device 11 of the user.

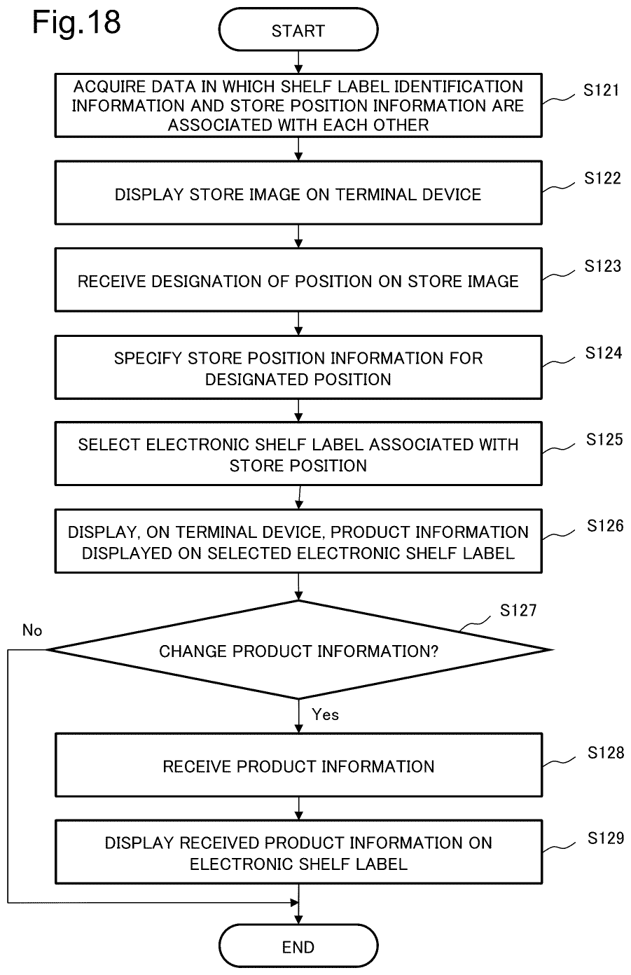

FIG. 18 is a flowchart illustrating an operation example regarding selection of the electronic shelf label D by the shelf label management system 10 according to the first example embodiment. The acquisition unit 101 acquires data in which shelf label identification information and store position information are associated with each other (step S121). In step S121, for example, the acquisition unit 101 acquires the shelf label DB 1002. The second output control unit 111 displays a store image on the display device of the terminal device 11 (step S122).

The position receiving unit 107 receives designation of a position on the store image (step S123). The designated position specifying unit 108 specifies store position information related to the designated position (step S124). Here, a position on the image and position information in the store related to this position may be associated in advance. In this case, in step S124, the position receiving unit 107 specifies position information associated with the designated position. Alternatively, in step S124, the designated position specifying unit 108 may estimate facility position information from the position of the image capturing device 14 that has captured the image and the angle of view of the image. Alternatively, the designated position specifying unit 108 may specify a shelf near the area of the designated position from the image and estimate facility position information from the position of the shelf.

The selection unit 109 selects an electronic shelf label D identified by the shelf label identification information associated with the specified store position information based on the acquired shelf label DB 1002 (step S125). The second output control unit 111 displays, on the terminal device 11, the product information displayed on the selected electronic shelf label D (step S126). For example, in step S126, the second output control unit 111 specifies the product information displayed on the electronic shelf label D from the store position information associated with the shelf label identification information of the selected electronic shelf label D based on the shelf label DB 1002 and the displayed product DB 1001. Then, in step S126, the second output control unit 111 displays the specified product information on the display device of the terminal device 11.

The product information receiving unit 112 determines whether to change the product information (step S127). For example, in step S127, the product information receiving unit 112 determines whether to change the product information depending on whether the button for changing the product information is tapped as illustrated in FIG. 15. In a case where the button for changing the product information is tapped, the product information receiving unit 112 determines to change the product information.

In a case where it is not determined to change the product information (step S127: No), the shelf label management system 10 ends the processing.

On the other hand, in a case where it is determined to change the product information (step S127: Yes), the product information receiving unit 112 receives product information (step S128). The first output control unit 104 displays the received product information on the electronic shelf label D (step S129). Then, the shelf label management system 10 ends the processing.

As described above, in the first example embodiment, identification information for identifying the electronic shelf label D is associated with position information indicating a position in a facility for each electronic shelf label D. Then, the shelf label management system 10 receives designation of a position on a facility image by means of an operation by a user, specifies facility position information related to the designated position, and selects the electronic shelf label D associated with the facility position information. Accordingly, it is possible to facilitate designation of the electronic shelf label D by the user. Furthermore, for example, the user can designate the electronic shelf label D even in a case where the user does not know where in the facility the electronic shelf label D is installed.

In addition, the shelf label management system 10 controls output of the selected electronic shelf label D. For example, the shelf label management system 10 may turn on the lighting device of the selected electronic shelf label D. For example, when the user is walking while searching for the electronic shelf label D, the lighting device of the electronic shelf label D selected using the terminal device 11 is turned on, and as a result, the user can easily find the electronic shelf label D. Alternatively, for example, the shelf label management system 10 may output new product information to the selected electronic shelf label D. Accordingly, the product information displayed on the selected electronic shelf label D can be updated.

In addition, the shelf label management system 10 outputs, to the terminal device 11 of the user, the product information that has been output to the selected electronic shelf label D. Accordingly, the user can confirm the product information displayed on the selected electronic shelf label D.

### <Notification Example of Wrong Position of Electronic Shelf Label D>

An example will be described in which, in a case where the electronic shelf label D is located at a different position from a position indicated by store position information associated in advance, the store clerk is notified that the electronic shelf label D is located at the wrong position.

After the shelf label identification information of the electronic shelf label D is associated with the store position information, the position specifying unit 102 may newly specify the store position information of the electronic shelf label D. Note that a time when the position specifying unit 102 newly specifies the position of the electronic shelf label D is not limited to a particular one. For example, the time may be a time designated by the user or a predetermined time such as once a day or once per predetermined time period. For example, in a case where the time is designated by the user, the instruction receiving unit 105 may receive a specification instruction of the position of the electronic shelf label D. When the instruction receiving unit 105 receives the specification instruction, the position specifying unit 102 newly specifies the store position information of the electronic shelf label D, for example.

The determination unit 113 determines the difference between the newly specified store position information and the store position information associated with the shelf label identification information of the electronic shelf label D. That is, the determination unit 113 determines whether the newly specified store position information is different from the store position information associated with the shelf label identification information of the electronic shelf label D. By doing so, the determination unit 113 can determine whether the electronic shelf label is not currently at the position where the product specified by the product information displayed on the electronic shelf label is arranged or outside the area where the product is arranged.

In a case where it is determined that the newly specified store position information is different from the store position information associated with the shelf label identification information of the electronic shelf label D, the notification unit 106 notifies the user of the difference. With this configuration, the notification unit 106 can notify the user in a case where the electronic shelf label is not currently at the position where the product specified by the product information displayed on the electronic shelf label is arranged or is not in the area where the product is arranged. The notification method is not limited to a particular one. The notification unit 106 may control the output of the electronic shelf label D in such a way that the user can determine that the position of the electronic shelf label D is wrong. For example, in a case of controlling the LED 131 of the electronic shelf label D, the notification unit 106 may perform the notification by turning on the LED 131 in a predetermined mode such as blinking the LED 131 of the electronic shelf label D or turning on the LED 131 of the electronic shelf label D in a predetermined color.

Alternatively, for example, the notification unit 106 may notify the terminal device 11 used by the user by an electronic message or an electronic mail.

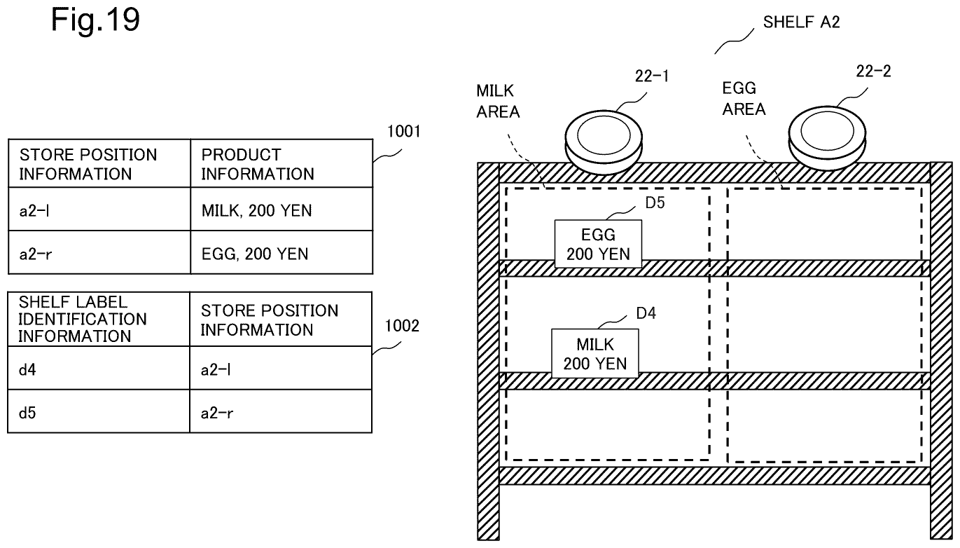

FIG. 19 is an explanatory diagram illustrating an example in which the electronic shelf label D is located in a different area from an area of a product associated with the electronic shelf label D. For example, in FIG. 19, the electronic shelf label D5 displays a product name “egg” and a price “200 yen” as the product information. In FIG. 19, in the shelf label DB 1002, the store position information a2-r is associated with the shelf label identification information d5 of the electronic shelf label D5. However, in FIG. 19, when newly detecting the position of the electronic shelf label D5, the position specifying unit 102 specifies the store position information a2-1.

The determination unit 113 determines that the newly specified store position information a2-1 is different from the store position information a2-r associated with the shelf label identification information d5 of the electronic shelf label D5. Therefore, the notification unit 106 notifies the user that the position of the electronic shelf label D5 is wrong.

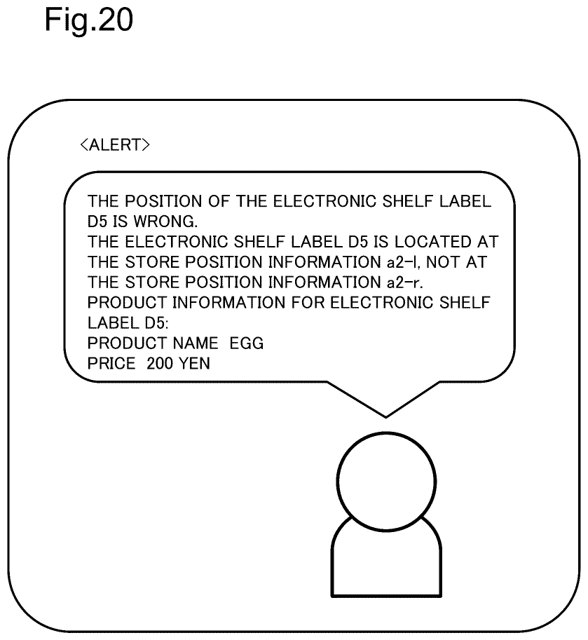

FIG. 20 is an explanatory diagram illustrating a first notification example. In FIG. 20, the notification unit 106 notifies the user via the second output control unit 111 that the position of the electronic shelf label D5 is wrong. Specifically, in FIG. 20, a screen including a state in which the position of the electronic shelf label D5 is wrong is displayed on the terminal device 11 of the user. In addition, in FIG. 20, the screen includes the store position information indicating the current position of the electronic shelf label D and the store position information associated with the shelf label identification information of the electronic shelf label D.

Although not illustrated, the notification unit 106 may display an image of a map of the store and display the current position indicated by the newly specified store position information newly in the image of the map on the terminal device 11 via the second output control unit 111.

In addition, the notification unit 106 may perform notification with the current image of the shelf on which the electronic shelf label D is installed. For example, in a case where the newly specified position information is different from the position information associated with the shelf label identification information of the electronic shelf label D, the image capturing control unit 110 takes control in such a way that the image capturing device 14 captures the image of the shelf on which the electronic shelf label D is installed. Then, the image capturing control unit 110 acquires the captured image of the shelf.

Here, the image capturing device 14 may constantly capture the image of the shelf, or may capture the image of the shelf in response to an image capturing instruction from the image capturing control unit 110 in a case where the newly specified position information is different from the position information associated with the shelf label identification information of the electronic shelf label D. For example, in a case where the image capturing device 14 constantly captures the image of the shelf, the image capturing control unit 110 only needs to acquire, from the image capturing device 14, an image of the shelf by which it can be identified that the newly specified position information is different from the position information associated with the shelf label identification information of the electronic shelf label D.

The image of the shelf on which the electronic shelf label D is installed may be an image of a fixture at a position indicated by the newly specified position information, or may be an image of a fixture at a position indicated by the position information associated with the shelf label identification information of the electronic shelf label D. The notification unit 106 may perform the notification by transmitting the captured image to the terminal device 11 of the user. Alternatively, the notification unit 106 may perform the notification by displaying the captured image on the terminal device 11 of the user.

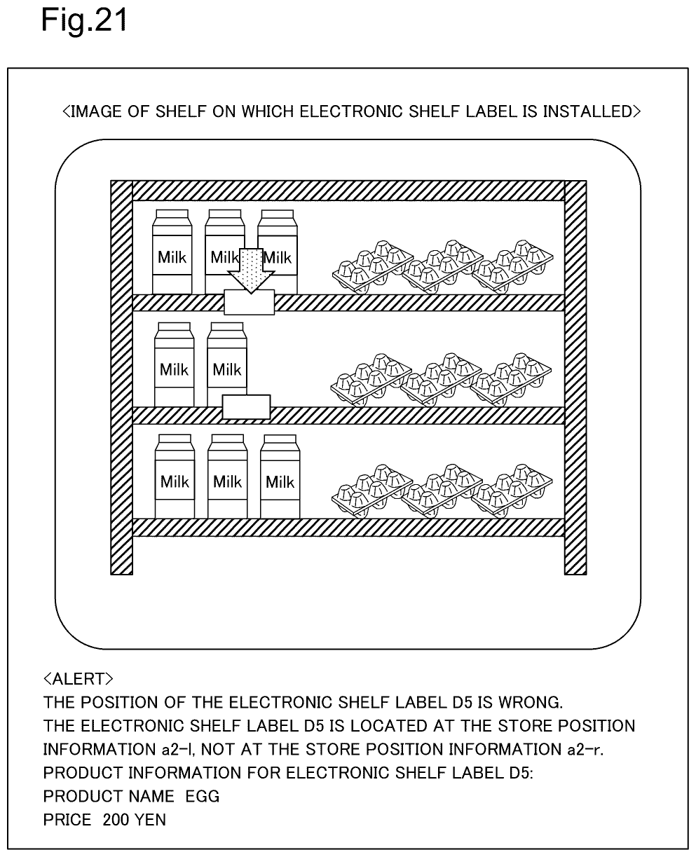

FIG. 21 is an explanatory diagram illustrating a second notification example. In FIG. 21, the notification unit 106 displays, on the terminal device 11 of the user, the image of the shelf on which the electronic shelf label D5 is installed via the second output control unit 111, and notifies the user that the position of the electronic shelf label D5 is wrong. The notification unit 106 may specify the electronic shelf label D5 from the image and superimpose and display a mark indicating the electronic shelf label D5 on the image. In FIG. 21, the mark is an arrow.

In addition, in the facility, an area in which a product is displayed may be determined in advance. The determination unit 113 may determine, based on the newly specified store position information, whether the current position of the electronic shelf label D is in the area of the product specified by the store position information associated with the shelf label identification information of the electronic shelf label D. In a case where the electronic shelf label D is not located in the area, the notification unit 106 notifies the user. The notification method is as described above.

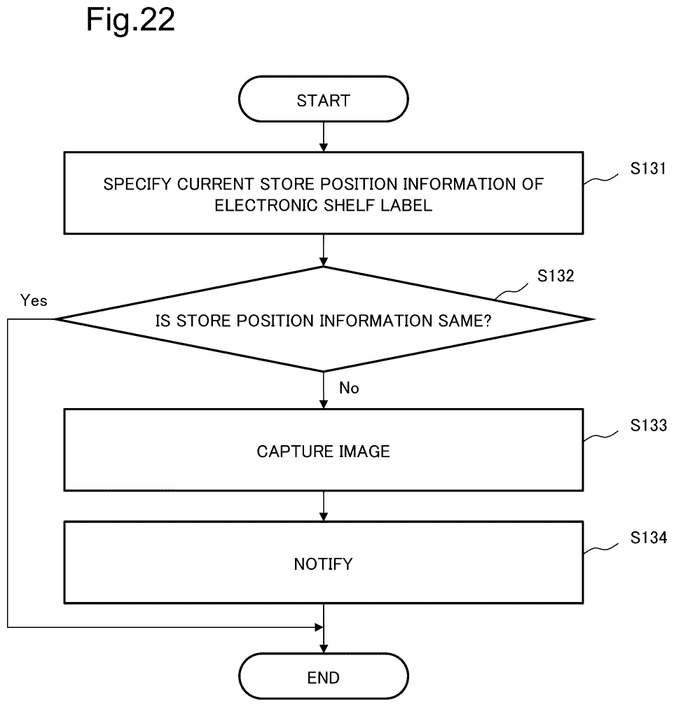

FIG. 22 is a flowchart illustrating an operation example regarding notification of a wrong position of the electronic shelf label D by the shelf label management system 10 according to the first example embodiment. First, after the shelf label identification information of the electronic shelf label D is associated with the store position information, the position specifying unit 102 specifies the store position information indicating the current position of the electronic shelf label D at a predetermined time (step S131).

Subsequently, the determination unit 113 determines whether the current store position information of the electronic shelf label D is the same as the store position information associated with the shelf label identification information of the electronic shelf label D in the shelf label DB 1002 (step S132). In a case where the current store position information of the electronic shelf label D and the store position information associated with the shelf label identification information of the electronic shelf label D in the shelf label DB 1002 are the same (step S132: Yes), the shelf label management system 10 ends the processing. On the other hand, in a case where the current store position information of the electronic shelf label D is different from the store position information associated with the shelf label identification information of the electronic shelf label D in the shelf label DB 1002 (step S132: No), the image capturing control unit 110 takes control in such a way that the image capturing device 14 captures an image of the shelf on which the electronic shelf label D is installed (step S133). Then, the notification unit 106 notifies the user (step S134), and the shelf label management system 10 ends the processing.

As described above, in the first example embodiment, the shelf label management system 10 notifies a user in a case where a current position of the electronic shelf label D is different from a position associated with the electronic shelf label D. Accordingly, the user can grasp that the position of the electronic shelf label D is wrong.

In addition, the shelf label management system 10 notifies the user with an image of the shelf captured in real time. This makes it easy for the user to confirm that the position of the electronic shelf label D is wrong.

### Second Example Embodiment

Next, a second example embodiment will be described in detail with reference to the drawings. In the second example embodiment, a basic function of a shelf label management system will be described. Hereinafter, description of contents overlapping with the above description will be omitted to the extent that the description of the second example embodiment is not unclear.

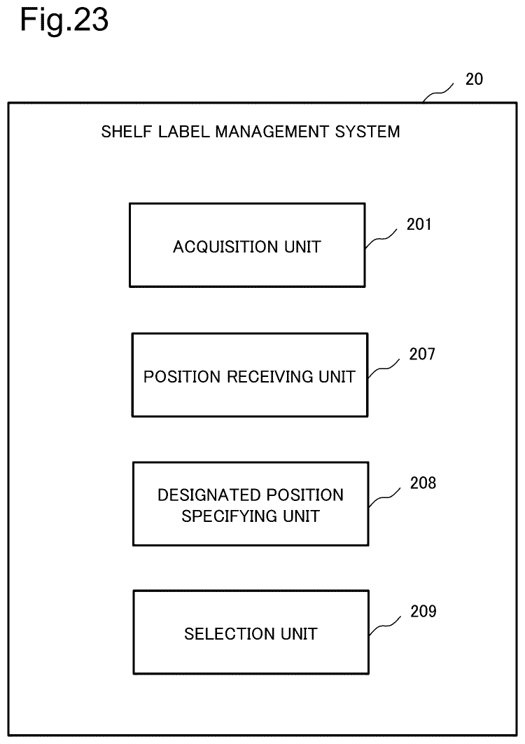

FIG. 23 is a block diagram illustrating a configuration example of a shelf label management system according to a second example embodiment. A shelf label management system 20 includes an acquisition unit 201, a position receiving unit 207, a designated position specifying unit 208, and a selection unit 209. The acquisition unit 201 is a basic function of the acquisition unit 101 in the first example embodiment. The position receiving unit 207 is a basic function of the position receiving unit 107 in the first example embodiment. The designated position specifying unit 208 is a basic function of the designated position specifying unit 108 in the first example embodiment. The selection unit 209 is a basic function of the selection unit 109 in the first example embodiment.

The acquisition unit 201 acquires, for each electronic shelf label, data in which shelf label identification information for identifying the electronic shelf label and position information indicating a position in a facility are associated with each other.

The position receiving unit 207 receives designation of a position on a facility image by means of an operation by a user. In a case where the facility is a store, the user is, for example, a store clerk or a customer. In a case where the facility is a warehouse or a factory, the user is, for example, a worker. Specifically, for example, the position receiving unit 207 receives designation of the position on the facility image by means of the operation by the user on a terminal device of the user.

The designated position specifying unit 208 specifies facility position information related to the designated position. Here, a position on the image and position information in the store related to this position may be associated in advance. In this case, the designated position specifying unit 208 specifies position information associated with the designated position. Alternatively, the designated position specifying unit 208 may estimate facility position information from the position of an image capturing device that has captured the image and the angle of view of the image. Alternatively, the position receiving unit 207 may specify a shelf near the area of the designated position from the image and estimate facility position information from the position of the shelf.

The selection unit 209 selects an electronic shelf label identified by shelf label identification information associated with the facility position information based on the acquired data.

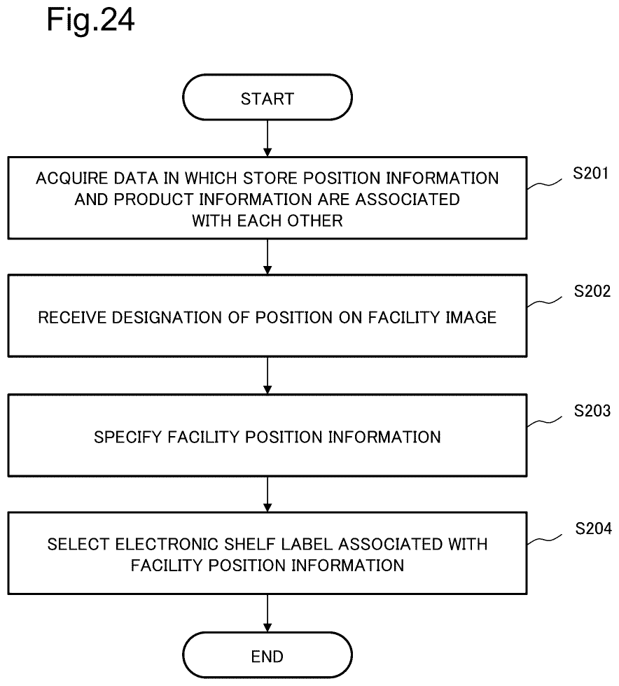

FIG. 24 is a flowchart illustrating an operation example of the shelf label management system 20 according to the second example embodiment. The acquisition unit 201 acquires, for each electronic shelf label, data in which identification information for identifying the electronic shelf label and position information indicating a position in a facility are associated with each other (step S201). The position receiving unit 207 receives designation of a position on a facility image by means of an operation by a user (step S202). The designated position specifying unit 208 specifies position information of the facility (step S203). The selection unit 209 selects an electronic shelf label identified by shelf label identification information associated with the facility position information (step S204), and ends the processing.

As described above, in the second example embodiment, the shelf label management system 20 acquires, for each electronic shelf label, data in which identification information for identifying the electronic shelf label and position information indicating a position in a facility are associated with each other. Then, the shelf label management system 20 receives designation of a position on a facility image by means of an operation by a user and specifies position information of the facility related to the designated position. The shelf label management system 20 selects an electronic shelf label identified by shelf label identification information associated with the facility position information. Accordingly, it is possible to facilitate designation of the electronic shelf label by the user. Furthermore, for example, the user can designate the electronic shelf label even in a case where the user does not know where in the facility the electronic shelf label is installed.

The description of each of the example embodiments ends. The example embodiments may be used in combination. Furthermore, for example, in each of the example embodiments, the shelf label management system may include some of the functional units and the information.

Each of the example embodiments is not limited to the above-described one and can be modified in various ways. The configuration of the shelf label management system in each of the example embodiments is not limited to a particular one. The shelf label management system may be achieved by one device such as one terminal device 11 and one server. Alternatively, the shelf label management system may be achieved by a different device per function or data kind. The shelf label management system may include a plurality of servers.

A target to be transmitted or received among the shelf label management system and other devices described in each of the example embodiments may be information itself or an identifier representing information, and is not limited to a particular one.

In each of the example embodiments, information may include some of the above-described information. Information may include information other than the above-described information. Information may be divided into a plurality of tables or a plurality of pieces of information more finely. In this manner, a method for achieving information is not limited to a particular one.

Each of the screens displayed on the terminal device 11 is an example, and is not limited to a particular one. In each of the screens, a button, a list, a check box, an information display field, an input field, and the like that are not illustrated may be added. The background color and the like of the screen may be changed.

Furthermore, for example, in each of the example embodiments, the processing of generating information or the like of a screen to be displayed on the terminal device 11 may be performed by the second output control unit of the shelf label management system or may be performed by the terminal device 11.

### (Hardware Configuration Example of Computer)

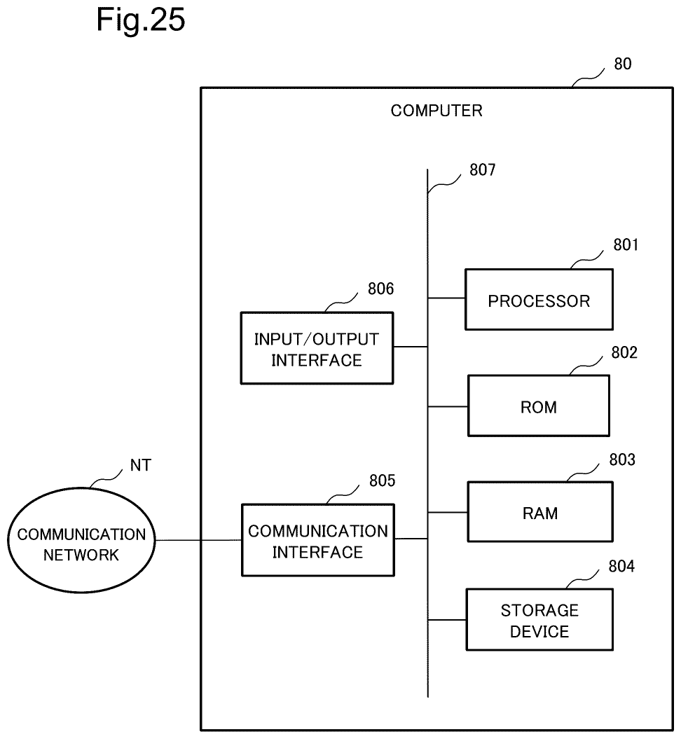

Next, a hardware configuration example in a case where the devices such as the shelf label management system and the terminal device described in each of the example embodiments are achieved by a computer will be described. FIG. 25 is an explanatory diagram illustrating a hardware configuration example of a computer. For example, some or all of the devices can be achieved by using a freely-selected combination of a computer 80 as illustrated in FIG. 25, for example, and a program.

The computer 80 includes, for example, a processor 801, a read only memory (ROM) 802, a random access memory (RAM) 803, and a storage device 804. the computer 80 also includes a communication interface 805 and an input/output interface 806. The components are connected via, for example, a bus 807. The number of pieces of each component is not limited to a particular number and is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), and a solid state drive (SSD). For example, the storage device 804 stores an operating system (OS) program, an application program, and a program according to each of the example embodiments. Alternatively, the ROM802 stores an application program, a program according to each of the example embodiments, and the like. The RAM803 is used as a work area of the processor 801.

The processor 801 loads a program stored in the storage device 804, the ROM802, or the like. Then, the processor 801 executes each piece of processing coded in the program. The processor 801 may download various programs via a communication network NT. The processor 801 functions as a part or all of the computer 80. The processor 801 may execute processing or instructions in the illustrated flowchart based on the program.

The communication interface 805 is connected to the communication network NT such as a local area network (LAN) or a wide area network (WAN) through a wireless or wired communication line. Note that the communication network NT may include a plurality of communication networks NT. Accordingly, the computer 80 is connected to an external device or an external computer 80 via the communication network NT. The communication interface 805 provides an interface between the communication network NT and the inside of the computer 80. The communication interface 805 controls input and output of data into and from the external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a loudspeaker that outputs sound. Examples of the input/output device include a touch panel display. The input device, the output device, the input/output device, and the like may be built in the computer 80 or may be externally attached.

The hardware configuration of the computer 80 is an example. The computer 80 may include some of the components illustrated in FIG. 25. The computer 80 may include a component other than those illustrated in FIG. 25. For example, the computer 80 may include a drive device or the like. Then, the processor 801 may read a program or data stored in a recording medium attached to the drive device or the like into the RAM 803. Examples of the non-transitory tangible recording medium include an optical disk, a flexible disk, a magneto-optical disk, and a universal serial bus (USB) memory. As described above, for example, the computer 80 may include the input device such as a keyboard and a mouse. The computer 80 may include the output device such as a display. The computer 80 may include the input device, the output device, and the input/output device.

The computer 80 may include various sensors that are not illustrated. The type of the sensor is not limited to a particular one. Examples of the sensor include an acceleration sensor, a gyro sensor, a magnetic sensor, a global positioning system (GPS) sensor. Other examples of the sensor include a fingerprint sensor, LiDAR (Light, Detection and Ranging), a proximity sensor, and an ambient light sensor.

The description of the hardware configuration of each device ends. There are various modification examples of the method for fulfilling the function of each device. For example, each device may be achieved by a freely-selected combination of a computer and a program different for each component. A plurality of components included in each device may be achieved by a freely-selected combination of a computer and a program.

A part or all of each component of each device may be achieved by an application specific circuit. A part or all of each component of each device may be achieved by a general-purpose circuit including a processor such as a field programmable gate array (FPGA). A part or all of each component of each device may be achieved by a combination of an application specific circuit, a general-purpose circuit, and the like. These circuits may be a single integrated circuit. Alternatively, these circuits may be divided into a plurality of integrated circuits. The plurality of integrated circuits may be connected via a bus or the like.

In a case where a part or all of each component of each device is achieved by a plurality of computers, circuits, and the like, the plurality of computers, circuits, and the like may be arranged in a centralized manner or in a distributed manner.

The shelf label management method described in each example embodiment is achieved by being executed by the shelf label management system. Furthermore, for example, the shelf label management method is achieved by a computer such as a server or the terminal device 11 executing a program prepared in advance. The program described in each example embodiment is recorded in a computer-readable recording medium such as an HDD, an SSD, a flexible disk, an optical disk, a flexible disk, a magneto-optical disk, or a USB memory. Then, the program is executed by being read from the recording medium by the computer. The program may be distributed via the communication network NT.

Each component of the shelf label management system in each example embodiment described above may be achieved in a hardware manner such as by using a computer. Alternatively, each component may be achieved by a computer based on program control or firmware.

Although the present disclosure has been described with reference to the example embodiments, the present disclosure is not limited to the example embodiments. Form and details of the present disclosure can include an example embodiment to which various changes that can be understood by those of ordinary skill in the art are applied within the spirit and scope of the present disclosure. The present disclosure may include an example embodiment in which the matters described in the present specification are appropriately combined or replaced as necessary. For example, the matters described using a specific example embodiment can be applied to another example embodiment as long as no contradiction occurs. For example, although the plurality of operations are described in order in the form of a flowchart, the described order does not limit the order of executing the plurality of operations. Therefore, when each example embodiment is implemented, the order of the plurality of operations can be changed within a range that does not interfere with the content.

A part or all of the above example embodiments can also be described as the following Supplementary Notes. However, a part or all of the above example embodiments is not limited to the following.

### (Supplementary Note 1)

A shelf label management system including
an acquisition means for acquiring, for each electronic shelf label, data in which shelf label identification information for identifying the electronic shelf label and position information indicating a position in a facility are associated with each other,
a position receiving means for receiving designation of a position on an image of the facility by means of an operation by a user,
a designated position specifying means for specifying the position information in the facility related to the position designated, and
a selection means for selecting the electronic shelf label identified by the shelf label identification information associated with the position information in the facility based on the data acquired.

### (Supplementary Note 2)

The shelf label management system according to Supplementary Note 1, including
a first output control means for controlling output of the electronic shelf label selected.

### (Supplementary Note 3)

The shelf label management system according to Supplementary Note 2, in which
the first output control means turns on a lighting device of the electronic shelf label selected.

### (Supplementary Note 4)

The shelf label management system according to Supplementary Note 2, in which
the first output control means outputs new product information to the electronic shelf label selected.

### (Supplementary Note 5)

The shelf label management system according to any one of Supplementary Notes 1 to 4, including
a second output control means for outputting, to a terminal device of the user, the product information that has been output to the electronic shelf label selected.

### (Supplementary Note 6)

The shelf label management system according to any one of Supplementary Note 1 to 5, including
a position specifying means for specifying position information indicating a position of the electronic shelf label in the facility, and
a notification means for notifying the user in a case where the position information newly specified is different from the position information associated with the shelf label identification information of the electronic shelf label.

### (Supplementary Note 7)

The shelf label management system according to claim 6, including
an image capturing control means for, in a case where the position information newly specified is different from the position information associated with the shelf label identification information of the electronic shelf label, taking control in such a way that an image capturing device captures an image of a fixture on which the electronic shelf label is installed, in which
the notification means transmits the image captured to the terminal device of the user.

### (Supplementary Note 8)

The shelf label management system according to any one of Supplementary Notes 1 to 7, in which
the facility is at least one of a store, a factory, and a warehouse.

### (Supplementary Note 9)

A shelf label management method including
acquiring, for each electronic shelf label, data in which shelf label identification information for identifying the electronic shelf label and position information indicating a position in a facility are associated with each other,
receiving designation of a position on an image of the facility by means of an operation by a user,
specifying the position information in the facility related to the position designated, and
selecting the electronic shelf label identified by the shelf label identification information associated with the position information in the facility based on the data acquired.

### (Supplementary Note 10)

A non-transitory computer-readable recording medium that records a program for causing a computer to execute processing including
acquiring, for each electronic shelf label, data in which shelf label identification information for identifying the electronic shelf label and position information indicating a position in a facility are associated with each other,
receiving designation of a position on an image of the facility by means of an operation by a user,
specifying the position information in the facility related to the position designated, and
selecting the electronic shelf label identified by the shelf label identification information associated with the position information in the facility based on the data acquired.

### (Supplementary Note 11)

A program for causing a computer to execute processing including
acquiring, for each electronic shelf label, data in which shelf label identification information for identifying the electronic shelf label and position information indicating a position in a facility are associated with each other,
receiving designation of a position on an image of the facility by means of an operation by a user,
specifying the position information in the facility related to the position designated, and
selecting the electronic shelf label identified by the shelf label identification information associated with the position information in the facility based on the data acquired.

### REFERENCE SIGNS LIST

10, 20 shelf label management system
11 terminal device
12 apparatus
12-1 apparatus
12-2 apparatus
14 image capturing device
80 computer
101, 201 acquisition unit
102 position specifying unit
103 association unit
104 first output control unit
105 instruction receiving unit
106 notification unit
107, 207 position receiving unit
108, 208 designated position specifying unit
109, 209 selection unit
110 image capturing control unit
111 second output control unit
112 product information receiving unit
113 determination unit
132 display device
801 processor
802 ROM
803 RAM
804 storage device
805 communication interface
806 input/output interface
807 bus
a2-1, a2-1-1, a2-1-2, a2-r store position information
A1, A2, A3, A4, A5, A6, A7, A8 shelf
D, D1, D2, D3, D4, D5, D6 electronic shelf label
1001 displayed product DB
1002 shelf label DB
NT communication network

What is claimed is:

1. A shelf label management system comprising:
at least one memory storing instructions; and
at least one processor configured to execute the instructions to:
acquire, for each electronic shelf label, data in which shelf label identification information for identifying the electronic shelf label and position information indicating a position in a facility are associated with each other;
receive designation of a position on an image of the facility by means of an operation by a user;
specify the position information in the facility related to the position designated; and
select the electronic shelf label identified by the shelf label identification information associated with the position information in the facility based on the data acquired.

2. The shelf label management system according to claim 1, wherein the at least one processor is further configured to execute the instructions to:
control output of the electronic shelf label selected.

3. The shelf label management system according to claim 2, wherein the at least one processor is further configured to execute the instructions to:
turn on a lighting device of the electronic shelf label selected.

4. The shelf label management system according to claim 2, wherein the at least one processor is further configured to execute the instructions to:
output new product information to the electronic shelf label selected.

5. The shelf label management system according to claim 1, wherein the at least one processor is further configured to execute the instructions to:
output, to a terminal device of the user, the product information that has been output to the electronic shelf label selected.

6. The shelf label management system according to claim 1, wherein the at least one processor is further configured to execute the instructions to:
specify position information indicating a position of the electronic shelf label in the facility; and
notify the user in a case where the position information newly specified is different from the position information associated with the shelf label identification information of the electronic shelf label.

7. The shelf label management system according to claim 6, wherein the at least one processor is further configured to execute the instructions to:
in a case where the position information newly specified is different from the position information associated with the shelf label identification information of the electronic shelf label, capture an image of a fixture on which the electronic shelf label is installed by an image capturing device;
transmit the image captured to the terminal device of the user.

8. The shelf label management system according to claim 1, wherein
the facility is at least one of a store, a factory, and a warehouse.

9. A shelf label management method comprising:
acquiring, for each electronic shelf label, data in which shelf label identification information for identifying the electronic shelf label and position information indicating a position in a facility are associated with each other;
receiving designation of a position on an image of the facility by means of an operation by a user;
specifying the position information in the facility related to the position designated; and
selecting the electronic shelf label identified by the shelf label identification information associated with the position information in the facility based on the data acquired.

10. A non-transitory computer-readable recording medium that records a program for causing a computer to execute processing comprising:
acquiring, for each electronic shelf label, data in which shelf label identification information for identifying the electronic shelf label and position information indicating a position in a facility are associated with each other;
receiving designation of a position on an image of the facility by means of an operation by a user;
specifying the position information in the facility related to the position designated; and
selecting the electronic shelf label identified by the shelf label identification information associated with the position information in the facility based on the data acquired.
